(19) United States
(12) Patent Application Publication
(10) Pub. No.: US 2010/0263672 A1
(43) Pub. Date: Oct. 21, 2010

(54) My personal clean air

(76) Inventor: Nand Kishore Acharya, Los Angeles, CA (US)

Correspondence Address: NAND KISHORE ACHARYA;APT. 104-335, 7095 HOLLYWOOD BOULEVARD, LOS ANGELES, CA, 90028, US

(21) Appl. No.: 12/386,218

(22) Filed: Apr. 15, 2009

(51) Int. Cl. A62B 7/10; B01D 47/02

(52) U.S. Cl. 128/206.11; 96/351; 96/227

(57) ABSTRACT

A liquid container and a battery operated blower. The container with blower will go across the shoulder with any available strap. Blower will deliver the air in the container at the bottom of the liquid. Clean and decontaminated air will rise and exit through nasal cannula tube and deliver the clean air at the users nostrils. If the battery runs out the user will be able to connect the provided attachment to the nasal cannula and put the attachment inside the nostrils. Attachment is designed to let user breathe in and breathe out without the need to remove the attachment. Also an air regulator provided in so the flow of air can be regulated as per need of the user.

### STATEMENT AS TO RIGHTS TO INVENTIONS MADE UNDER FEDERALLY SPONSORED RESEARCH AND DEVELOPMENT

Not Applicable

### FIELD OF THE INVENTION

This invention, a specially designed nasal cannula attachment, liquid container and battery powered blower, more particularly, a nasal cannula attachment, a liquid container and battery powered blower for delivering a clean and decontaminated air to the person.

### BACKGROUND OF INVENTION

Clean and virus free air is absolutely necessary to human health. Each person require a steady dose of clean air. When a person's air is not clean or saturated with harmful bacteria or viruses, that person becomes ill and may be even die without proper medication. Virus and harmful bacteria travel through air and in most cases it enters human body through our nose while we breathe in.

### OBJECT OF THE INVENTION

Known masks and respirators and air filters covers a person's nose and mouth. These respirators are bulky and have to be taken off while eating or drinking and risks catching infections during, such as flu pandemic. A need, therefore, exists for a lightweight portable device which does not have to be taken off and continues to allow clean air while eating, drinking, talking. This invention is a light weight portable device which delivers clean and decontaminated air.

Object of the invention is to provide an apparatus or a device whereby atmospheric air may be purified both chemically and mechanically to produce a pure air having any desired properties, that is, any desired or required amount of moisture, and also medicated or otherwise treated so as to impose the physical condition of the user and thereby prevent the user from being infected from the airborne harmful bacteria and viruses.

Another object of the invention is to provide a portable device which can be carried across the shoulder FIG. 1 when the user goes to the crowded places, like airplane, crowded bus and theatre.

Further another object of the invention is to provide a device which can be used equally efficiently even when the user runs out of power and is enable to find replacement batteries.

Yet still further object of this invention is, in the times of outbreak air viruses disease such as influenza, bird flue, this device will work as first line of defense. User can be protected while at work and travel to and from work, while our scientists invent proper anti biotic and vaccination.

There are many different types of gas masks and filtering devices are in use. However the solid filtering media present a problem to user. The filtration medium used in gas masks and respirators eventually becomes saturated with contaminants from the filtered air and requires periodical replacement. Solid filtration medium is expensive and can be difficult to accomplish.

In many prior arts liquid is used for air filtration in industries and many types of masks are used to cover nose and mouth, but none is useful for a user when that person is walking, talking, eating and taking fluid.

### SUMMARY OF THE INVENTION

Present invention is a portable device that filters air for personal use. Unfiltered air is drawn into container through the tube, at the bottom of the liquid, by a blower. Then the filtered air is directed to the nose with the help of a nasal cannula

Blower and the liquid container assembly can be located under the arm by the waist with the strap like shown in the FIG. 1.

The present invention addresses the problems with existing filters and respirators being used. The user will be able to move outdoor freely in the event of a flu pandemic. User will be able to walk, talk, eat and drink fluid while the device is on.

User will be able to travel in the over crowded airplanes without the fear of catching harmful airborne bacteria or viruses.

In third world emerging markets tuber clauses is prevalent and user will be able to conduct his or her business without fear of catching tuberculoses, while the device is on.

User will be able to travel in the over crowded buses with out the fear of catching an infection with airborne viruses.

User will be able to enjoy over crowded theatres and movie halls with no fear of catching airborne infections.

This device has an additional feature, an attachment which the user will carry with him or her all times.

If and when batteries runs out, the user will plug in the said attachment to nasal cannula and the attachment will sit in the nostrils of the user as shown in the FIG. 9A and he or she can detach the tube 14 from regulator 15 as shown in FIG. 2B

Specially designed attachment FIGS. 8 and 8A. are the hollow tubes and fairly tight skin, middle long tube and several small tube

User will be able to breathe in and breathe out without removing the attachment. User will breathe in through the middle tube and the air will come through the liquid in the container and will breathe out through outside tubes and the air will be guided out under the skin.

Container is the light weight plastic or other manmade material.

Device is fitted with the 15 air regulator FIG. 2, so the user can regulate the flow of air.

In time of outbreak of diseases such as influenza or tuber clauses, user can fill the container with hydrogen peroxide solution or even sea salt and the water in the container or water purifying tablet.

### BRIEF DESCRIPTION OF DRAWINGS:

FIG. 1 shows how the user will wear the personal air filtration device across the shoulder while walking.

FIG. 2 Personal air filtration system a liquid chamber 12, a battery powered blower 18 and 20, an air regulator 15, an air flow tube 17, a top 11 to put liquid and the air outlet 13.

FIG. 2A Blow up of batteries and blower of the filtration device.

FIG. 2B is, when and if the batteries run down and when the attachment FIG. 8 is used as shown in FIG. 9B, user will unplug the tube from air regulator 15, and the air will be coming from tube 14, instead of blower.

FIG. 3 is another elevation view of the rear of the device.

FIG. 4 is an elevation view of the side of the container.

FIG. 5 is another elevation view of the side of the container.

FIG. 6 is the top plan view of the container.

FIG. 7 is the bottom plan view of the container.

FIG. 8 is the attachment for the nasal cannula. When the user runs out of the batteries and is unable to find replacement he can use attachment and breathe through the liquid via middle hollow tube and breathe out through external hollow tubes under the skin without taking it off.

FIG. 8A is defragmented view of the attachment.

FIG. 9 is how the user will wear nasal cannula with out the attachment.

FIG. 9A is, how the user will wear nasal cannula with attachment when and if the batteries runs down.

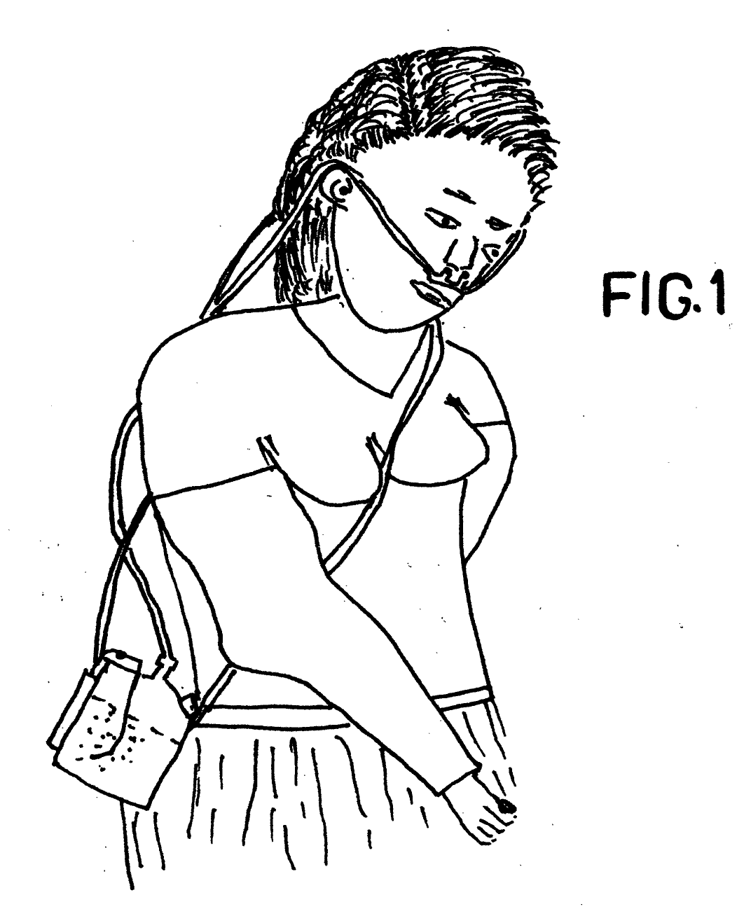

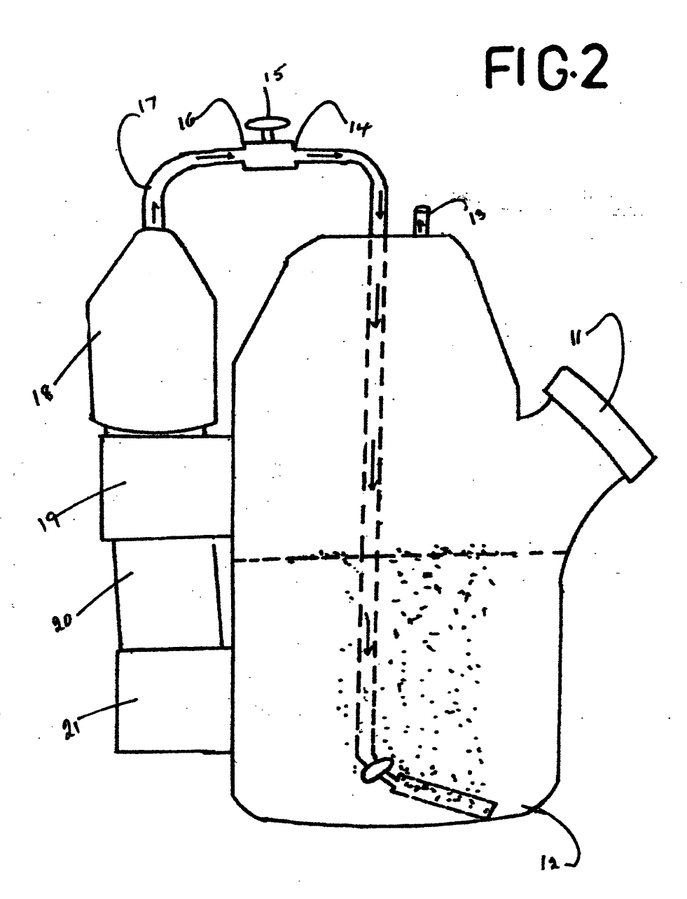

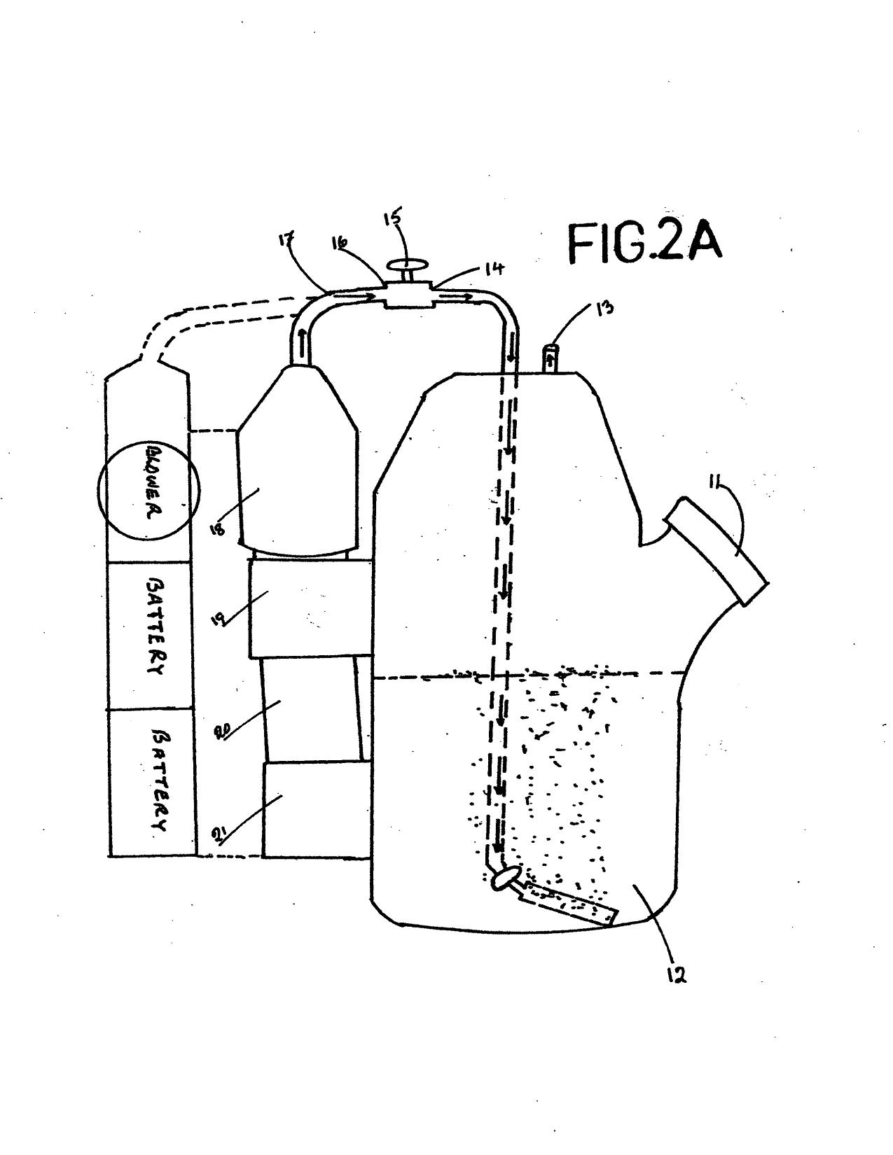

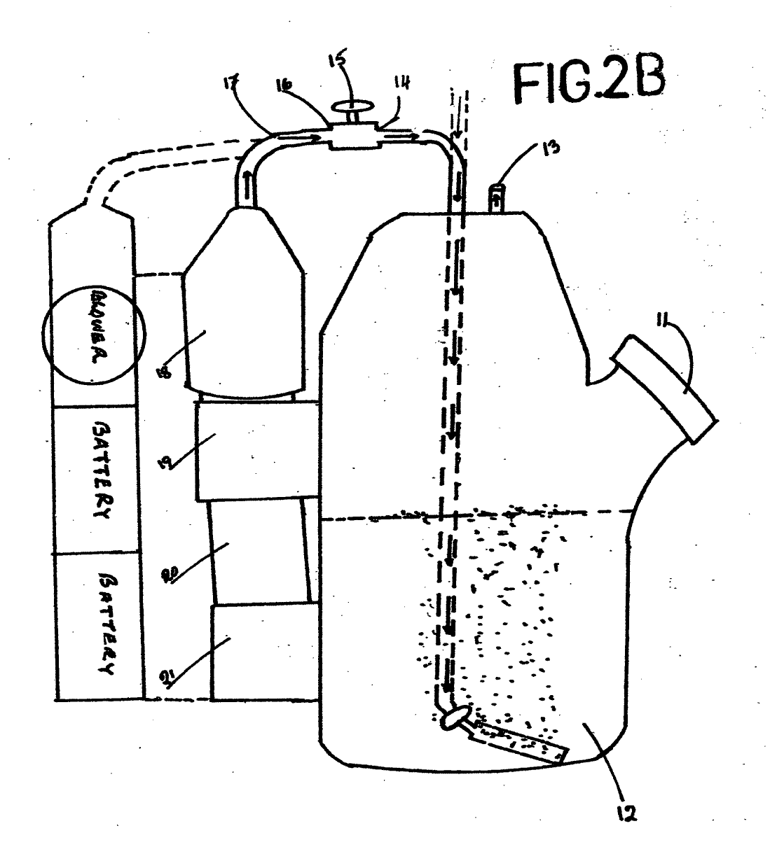

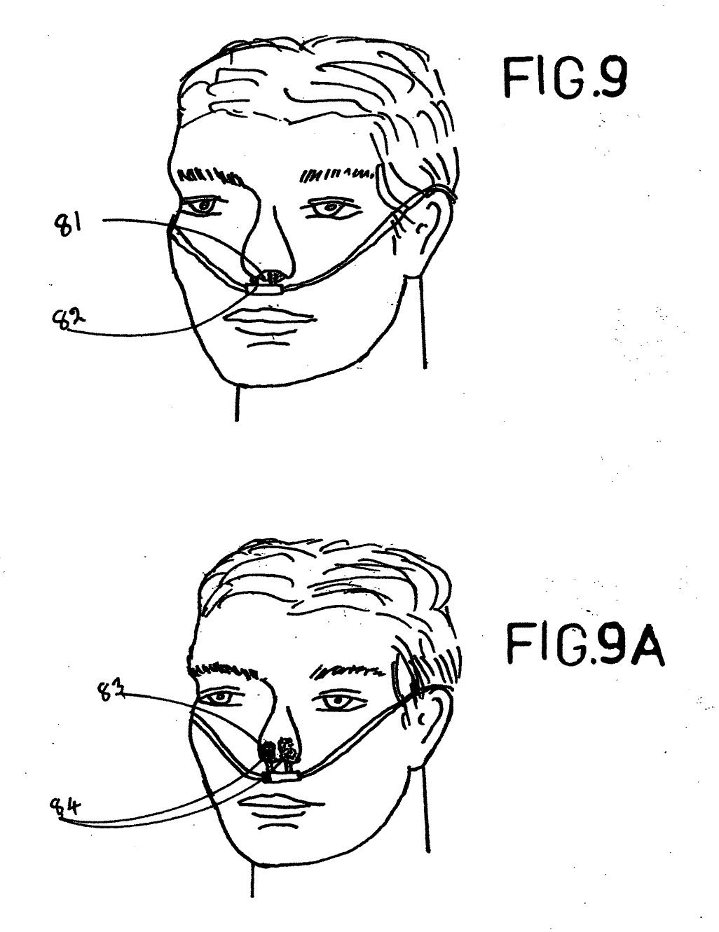

1) Personal air filtration device. FIG. 2, a liquid chamber, a blower with batteries, an air regulator, an attachment FIG. 9, an air inlet tube extending from blower into the said chamber at the bottom of the water, a flexible tube from the said outlet opening.

2) Personal air filtration where as environmental air is delivered through the said air inlet at the bottom of the water in the said chamber and the air is filtered by the quantity of water or disinfectant like Hydrogen Peroxide Solution housed within the chamber And the filtered air is inhaled through the said air outlet assembly and delivered to a user via nasal cannula.

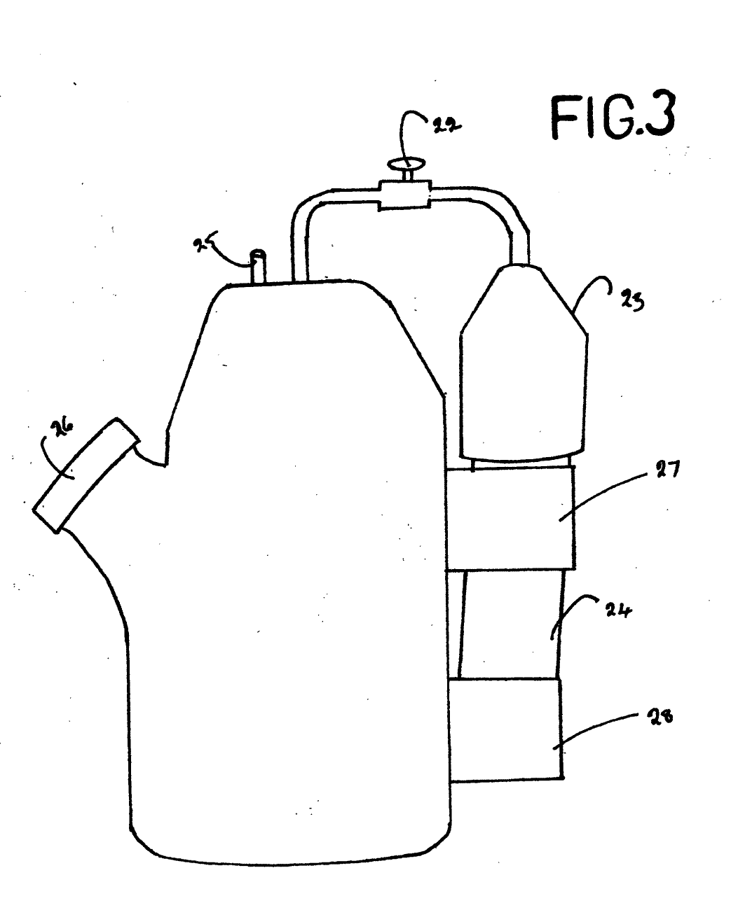

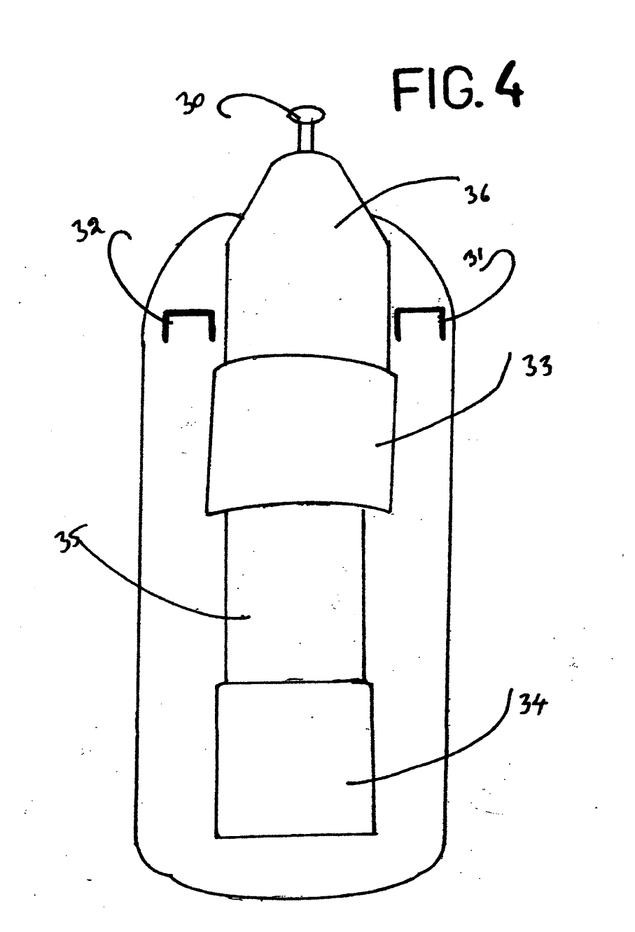

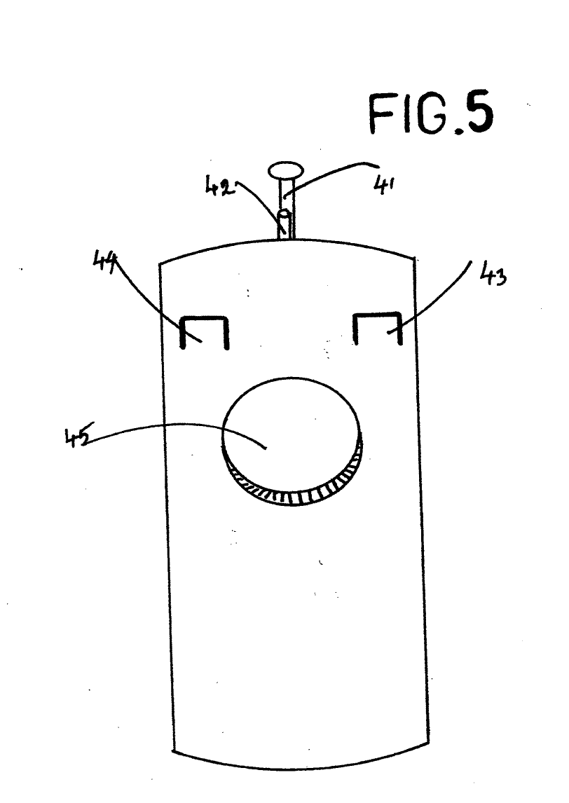

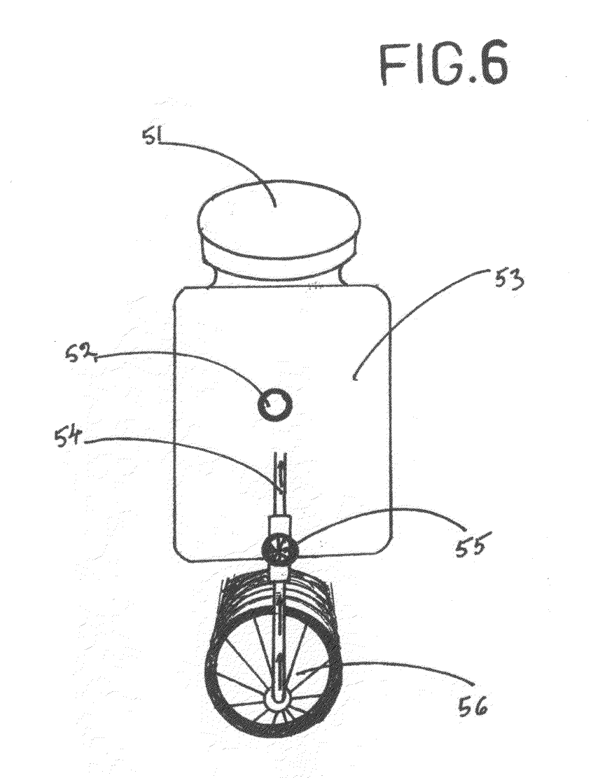

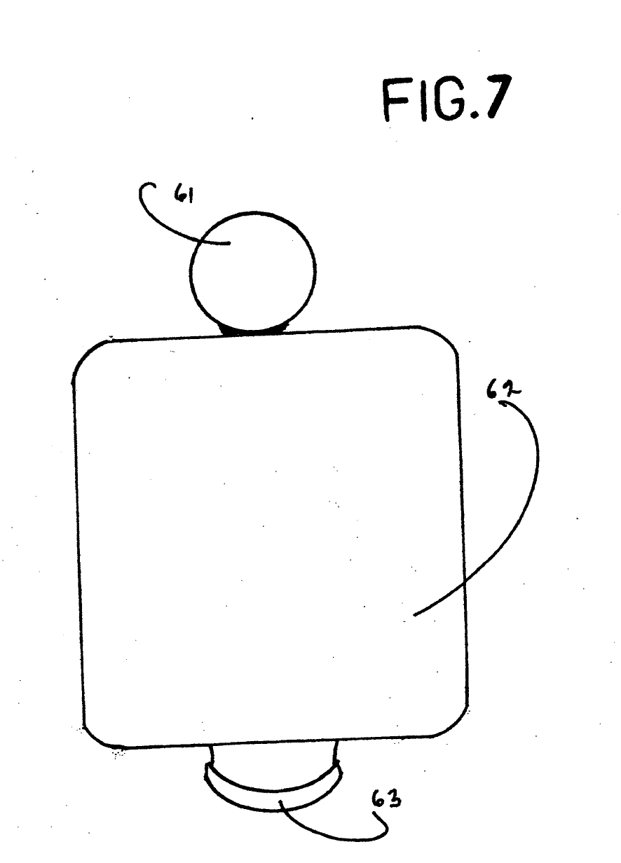

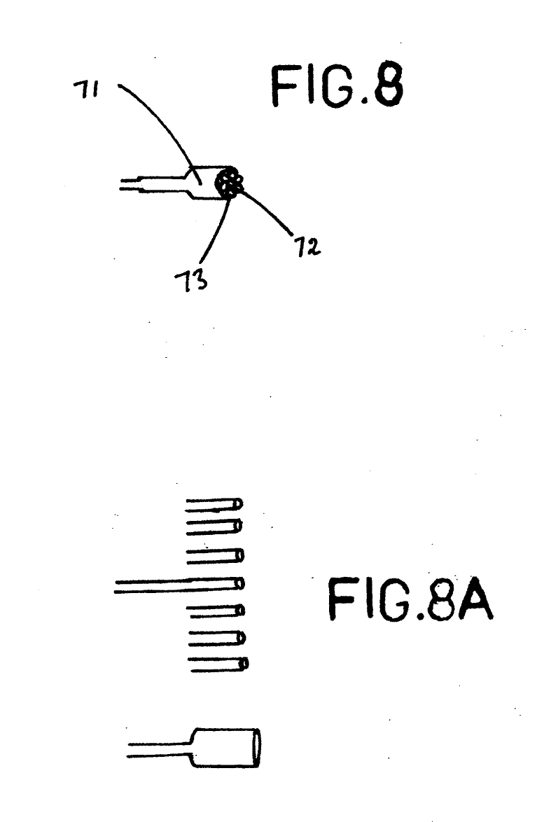

3) A two way attachment to sit inside nostrils so the user can breathe in and out without the need of taking it off. User will unplug the tube 14 from the regulator 15, FIG. 3B, so he or she can breathe in the purified air with out any obstruction or with out the battery powered blower.
